(19) United States
(12) Patent Application Publication
(10) Pub. No.: US 2019/0123936 A1
(43) Pub. Date: Apr. 25, 2019

(54) COMMUNICATION APPARATUS, COMMUNICATION METHOD, AND RECORDING MEDIUM

(71) Applicant: NEC Corporation, Minato-ku, Tokyo (JP)

(72) Inventors: Yuki HAYASHI, Tokyo (JP); Jun SUZUKI, Tokyo (JP); Masaki KAN, Tokyo (JP)

(73) Assignee: NEC Corporation, Minato-ku, Tokyo (JP)

(21) Appl. No.: 16/092,532

(22) PCT Filed: Apr. 14, 2017
(86) PCT No.: PCT/JP2017/015216

§ 371 Date: Oct. 10, 2018

(30) Foreign Application Priority Data
Apr. 21, 2016 (JP) 2016-085014

(51) Int. Cl. H04L 12/54; H04L 13/08

(52) U.S. Cl. CPC H04L 12/56; H04L 2012/5681; H04L 13/08

(57) ABSTRACT

In order to achieve a communication apparatus capable of efficiently transmitting data, the present invention is provided with a plurality of buffers configured to cause a communication packet to wait therein, and an intra-buffer packet switching means for moving a predetermined communication packet among packets waiting in the plurality of buffers from a first buffer in which the predetermined communication packet waits to a second buffer among the plurality of buffers.

### TECHNICAL FIELD

The present invention relates to a communication apparatus, a communication method, and a program.

### BACKGROUND ART

In order to achieve real-time communication by using a low-performance central processing unit (CPU) such as an embedded CPU, it is necessary to reduce a load of a CPU, and to preform high-precision control of transmission and reception of data. For this reason, devices equipped with a function of controlling a transmission rate of a network and a priority control function as functions on a network interface card (NIC) have appeared.

The rate control function and the priority control function installed in these NICs are mounted as hardware functions on the NIC. Thus, when the number of flows being a series of data using the NIC increases, a hardware processing capacity of the NIC decreases. Note that, a flow is formed of a plurality of communication packets.

Then, in PTL 1, as illustrated in FIG. 8, a destination distributing unit divides packets (one unit of information transmission) of a plurality of kinds corresponding to a plurality of flows, into groups, distributes the groups to a plurality of packet processing units, and disperses processing of a packet.

The destination distributing unit in FIG. 8 divides packets of a plurality of kinds sent from a transmission application into groups and distributes the groups to buffers connected to packet processing units. A group change applying unit performs an operation of changing groups of packets distributed by the destination distributing unit as necessary. A buffer 1 and a buffer 2 are buffers for each causing a packet to wait therein until the packet is sent to the packet processing unit. A packet processing unit 1 and a packet processing unit 2 each send a processed packet to a transmission unit which is not illustrated.

In FIG. 8, a-1, a-2, and so on indicate packets for a destination a, and numbers indicate an order of the packets. Further, b-1, b-2, and so on indicate packets for a destination b, and numbers indicate an order of the packets.

It is considered herein that the group change applying unit changes a distribution destination of packets for the destination b from the packet processing unit 1 to the packet processing unit 2, from a state as in (1) of FIG. 8 where packets for the destination a and for the destination b wait in the buffer 1 in a mixed manner.

In (2) of FIG. 8, a packet b-4 is blocked in the destination distributing unit until all packets are output from the buffer 1 in order not to reverse an order of the packet b-4 and packets b-2 and b-3 remaining in the buffer 1. Then, when all the packets are output from the buffer 1, packets subsequent to b-4 are distributed and sent to a destination after the change as in (3) of FIG. 8.

### CITATION LIST

### Patent Literature

[PTL 1] Japanese Unexamined Patent Application Publication No. 2010-161546

### SUMMARY OF INVENTION

### Technical Problem

According to a communication apparatus in PTL 1 illustrated in FIG. 8, a packet (packet b-4 in (2) of FIG. 8) after the group change is retained in the destination distributing unit until a packet waiting in the buffer 1 before the group change is sent. Thus, efficiency of sending data from the communication apparatus decreases.

A communication apparatus, a communication method, and a program according to the present invention are able to efficiently transmit data in comparison with a related technology.

### Solution to Problem

In order to achieve the above-described object, a communication apparatus according to the present invention includes a plurality of buffers configured to cause a communication packet to wait therein, and an intra-buffer packet switching means for moving a predetermined communication packet among packets waiting in the plurality of buffers from a first buffer in which the predetermined communication packet waits to a second buffer among the plurality of buffers.

In order to achieve the above-described object, a communication method according to the present invention includes moving a predetermined communication packet among communication packets waiting in a plurality of buffers from a first buffer in which the predetermined communication packet waits to a second buffer among the plurality of buffers.

In order to achieve the above-described object, a program according to the present invention includes moving a predetermined communication packet among communication packets waiting in a plurality of buffers from a first buffer in which the predetermined communication packet waits to a second buffer among the plurality of buffers.

### Advantageous Effects of Invention

According to a communication apparatus, a communication method, and a program of the present invention, data are able to be efficiently transmitted in comparison with a related technology.

### BRIEF DESCRIPTION OF DRAWINGS

FIG. 1 is a diagram illustrating an example of a configuration of a first example embodiment.

FIG. 2 is a diagram illustrating an example of a configuration of the first example embodiment.

FIG. 3 is a diagram illustrating an example of a configuration of the first example embodiment.

FIG. 4 is a diagram illustrating an example of a configuration of a second example embodiment.

FIG. 5 is a diagram illustrating an example of a configuration of the second example embodiment.

FIG. 6 is a diagram for describing operations in the first example embodiment.

FIG. 7 is a diagram for describing operations in the second example embodiment.

FIG. 8 is a diagram for describing operations in a related technology.

FIG. 9 is a diagram for describing operations in the first example embodiment.

FIG. 10 is a diagram for describing operations in the second example embodiment.

FIG. 11 is a diagram for describing operations in the second example embodiment.

FIG. 12 is a diagram for describing operations in the first example embodiment.

FIG. 13 is a diagram for describing operations in the second example embodiment.

FIG. 14 is a diagram illustrating an example of a configuration of the second example embodiment.

FIG. 15 is a diagram illustrating an example of a configuration of a third example embodiment.

FIG. 16 is a diagram for describing operations in the second example embodiment.

FIG. 17 is a diagram for describing operations in the second example embodiment.

### EXAMPLE EMBODIMENT

### First Example Embodiment

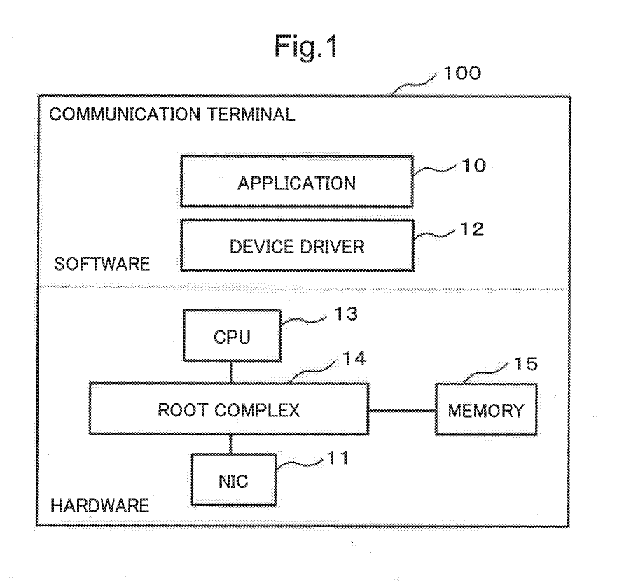

Next, an example embodiment of the present invention will be described in detail with reference to FIGS. 1 to 3, 6, 9, and 12.

### [Description of Configuration]

An overall configuration of a first example embodiment is illustrated in FIG. 1.

A communication terminal 100 in the present example embodiment includes, as hardware, a CPU 13 that controls the communication terminal 100, a root complex 14, an NIC 11, and a memory 15.

The CPU 13 is a central processing unit described above. Each device of the communication terminal 100 is connected to the root complex 14. The NIC 11 is a network interface card described above. Note that, the NIC 11 is a structural component of the communication terminal 100, but the NIC 11 may be referred to as a communication apparatus. The memory 15 is a storage element.

Further, the communication terminal 100 includes, as software, an application 10 that generates data transmitted to another communication terminal and a device driver 12 that performs control of transmission and reception of data on the NIC 11.

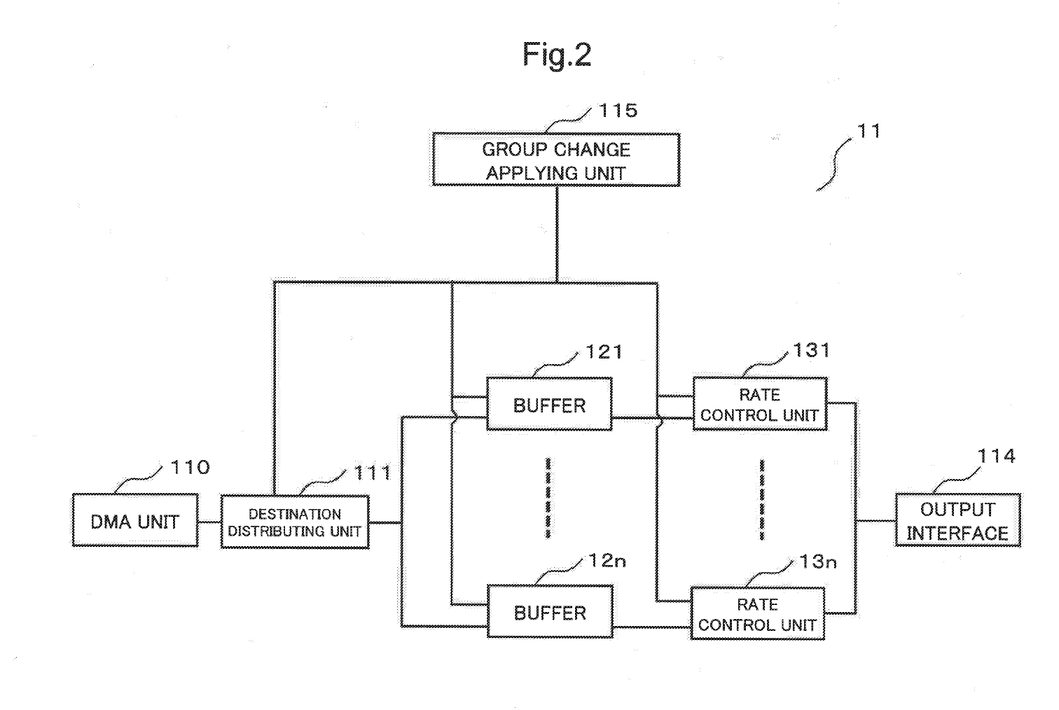

Next, a configuration of the NIC 11 is illustrated in FIG. 2.

The NIC 11 includes a direct memory access (DMA) unit 110, a destination distributing unit 111, buffers 121 to 12n, rate control units 131 to 13n, an output interface (I/F) 114, and a group change applying unit 115.

The DMA unit 110 reads data saved in the memory 15 by the device driver 12 and the application 10. Furthermore, the DMA unit 110 is a means for generating a plurality of communication packets (hereinafter packets) from data read from the memory 15, based on a communication method used for transmission to another communication terminal, and sending the packets to the destination distributing unit 111.

The packet is a transmission unit of data. The packet includes a data unit and a header unit. Further, the header unit is provided with a flow ID and a packet number.

The flow ID is an identification (ID) commonly provided to a series of packets (referred to as a flow) generated from data before the packets are generated.

Further, the packet number is an order of packets in a flow.

The group change applying unit 115 is a means for instructing the destination distributing unit 111 to divide a plurality of flows into groups for each of the buffers 121 to 12n and distribute the groups. Note that, the instruction from the group change applying unit 115 to the destination distributing unit 111 is performed by transmitting information in which numbers of the buffers 121 to 12n are associated with flow IDs assigned to the buffers as in an example illustrated in FIG. 6.

The buffer 121 to the buffer 12n are memories in which a packet sent from the destination distributing unit 111 is caused to temporarily wait.

The rate control units 131 to 13n perform processing of setting a packet in the buffer 121 to the buffer 12n at a predetermined rate and sending the packet to the output interface 114. The rate control units 131 to 13n may be referred to as packet processing units. The output interface 114 is an output means for transmitting data to another communication terminal.

The group change applying unit 115 is a means for changing a group setting performed by the destination distributing unit 111 by an appropriate procedure according to an instruction from a user or a management node.

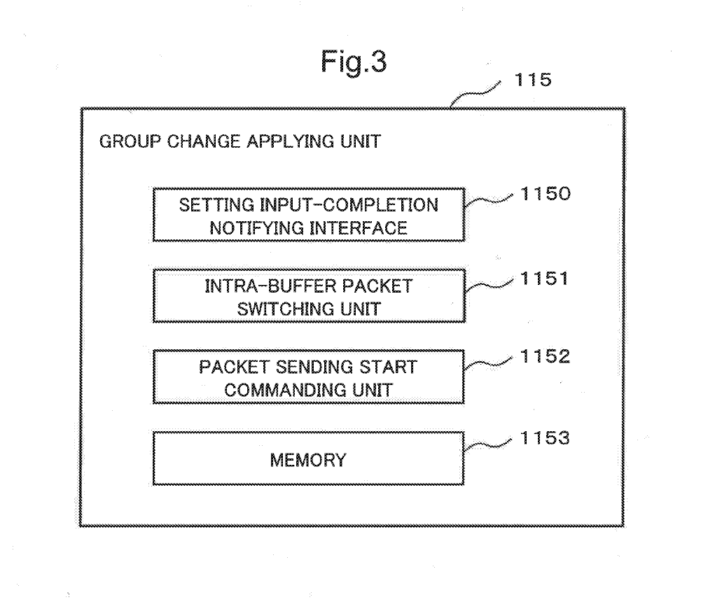

Herein, an example of a configuration of the group change applying unit 115 is illustrated in FIG. 3. The group change applying unit 115 includes a setting input-completion notifying interface 1150, an intra-buffer packet switching unit 1151, a packet sending start commanding unit, and a memory 1153.

The setting input-completion notifying interface 1150 notifies a notification destination that a request to change a setting of the destination distribution unit has been received from a user or a management node and the change in the setting has been completed by the destination distributing unit as necessary. The intra-buffer packet switching unit 1151 moves, when receiving a request to change a group setting from a user or a management node, a packet included in a buffer to another buffer according to a content of the change.

The packet sending start commanding unit 1152 includes a CPU that controls another structural component of the group change applying unit. The memory 1153 is a storage element that stores a current group setting and a group setting after a change when the change is instructed. When a group change in the NIC 11 is completed, the memory 1153 rewrites a content of the group setting after the change as a content of a current group setting.

### [Description of Operation]

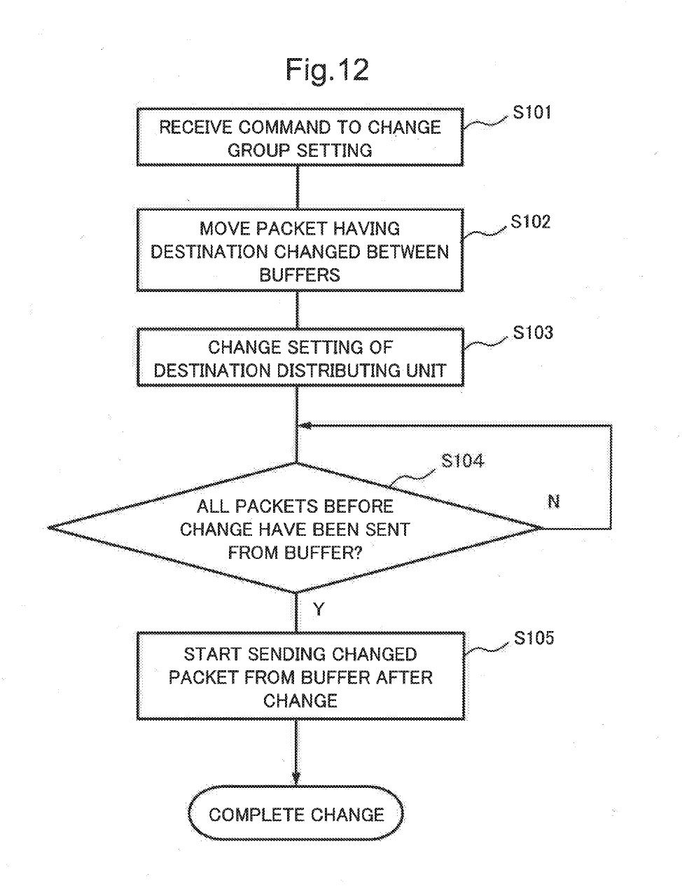

Next, operations in the present example embodiment will be described with reference to FIGS. 9 and 12.

Operations when the NIC 11 receives a command to change packets having b as the flow ID from the rate control unit 131 to the rate control unit 13n from a state of the NIC 11 where packets having a as the flow ID and the packets having b as the flow ID wait in a mixed manner as illustrated in (1) of FIG. 9 will be described.

Note that, a condition and a method of changing a rate control unit of a flow are not the point of the present invention, and thus description thereof will be omitted.

In a flowchart illustrated in FIG. 12, first, the setting input-completion notifying interface 1150 of the group change applying unit 115 receives a command to change a group setting (S101). Herein, the command to change a group setting may be dispatched from another node connected to the same network as the communication terminal 100 and received by the setting input-completion notifying interface 1150 via a reception interface, which is not illustrated, of the NIC 11. Alternatively, the command to change a group setting may be dispatched from the application 10 of the communication terminal 100 incorporating the NIC 11 and received by the setting input-completion notifying interface 1150.

Furthermore, in Step S101, the memory 1153 stores the group setting after the change received by the setting input-completion notifying interface 1150 (S101).

Next, in Step S102, the intra-buffer packet switching unit 1151 of the group change applying unit 115 refers to the memory 1153 and compares the group setting after the change with a current group setting. Then, as illustrated in (2) of FIG. 9, the intra-buffer packet switching unit 1151 moves a packet having a distribution destination changed among packets waiting in the buffers 121 to 12n to another buffer by a method described later (S102).

In (1) of FIG. 9 and (2) of FIG. 9, packets b-2 and b-3 waiting in the buffer 121 are moved to the buffer 12n.

Note that, in Step S102, when a packet is moved between buffers, a packet to be sent from a buffer to a rate control unit, such as the packet b-1 illustrated in (1) of FIG. 9, may be divided, and thus moving of the packet is not performed.

Further, the packet sending start commanding unit 1152 causes a packet that has arrived at the destination distributing unit 111 during the operation in Step S102 to wait in the destination distributing unit 111 without sending the packet to the buffers 121 to 12n.

Furthermore, in Step S102, when the setting input-completion notifying interface 1150 receives the command to change a group setting, the packet sending start commanding unit 1152 instructs a buffer being a movement destination of a packet to stop sending a moved packet to a rate control unit (S102).

In the example of (2) of FIG. 9, the packet sending start commanding unit 1152 instructs the buffer 2 to stop sending in such a way that the packets b-2 and b-3 that have moved from the buffer are not output from the buffer 2 being a movement destination to the rate control unit.

Herein, a method of moving a packet waiting in a buffer to another buffer will be described.

The packet includes, as a header, information about a flow ID and an order of packets (hereinafter a packet number) in the same flow ID together with data. Further, the intra-buffer packet switching unit 1151 is always able to refer to a header of each packet waiting in each buffer.

The intra-buffer packet switching unit 1151 refers to the memory 1153, compares the group setting after the change with a current group setting, and recognizes a buffer being a current distribution destination of a flow ID (hereinafter a movement flow ID) having a distribution destination changed and a buffer after the change. Then, the intra-buffer packet switching unit 1151 refers to a header of a packet waiting in a buffer to which the movement flow ID is currently distributed.

The intra-buffer packet switching unit 1151 refers to the header, extracts a packet having the smallest packet number from packets having the movement flow ID, and moves the packet to an end of packets waiting in a buffer being a movement destination. The work of extracting a packet having the smallest packet number from packets having the movement flow ID and moving the packet to an end of packets waiting in the buffer being the movement destination is repeated until there is no packet having the movement flow ID in the buffer being the current distribution destination.

As described above, a packet waiting in a buffer is moved to another buffer.

In Step S103 subsequent to Step S102, the memory 1153 rewrites information about a current group setting to a content of the group setting after the change. Further, the packet sending start commanding unit 1152 instructs the destination distributing unit 111 to change the group setting to the group setting after the change. Then, the destination distributing unit 111 distributes a packet, based on the group setting after the change, and starts sending the packet to a buffer being a distribution destination (S103).

Next, the packet sending start commanding unit 1152 determines whether or not all packets (packets b in FIG. 9) being switching targets in Step S102 have been sent from the buffer (buffer 121 in FIG. 9) to which the packets have been distributed before switching (S104).

In Step S104, when it is determined that all the packets being the switching targets have been sent from the buffer (Y in S104), processing proceeds to Step S105. In Step S104, when it is determined that all the packets being the switching targets have not been sent from the buffer (N in S104), processing returns to Step S104.

In Step S105, the buffer (buffer 12n in FIG. 9) that has been instructed to stop sending to the rate control unit in Step S102 is instructed to start sending a packet. Then, the packet sent from the buffer 12n in FIG. 9 undergoes processing of setting the packet at a predetermined rate in the rate control unit 13n and is transmitted from the output interface 114 in FIG. 2 to another communication terminal (S105).

The work of changing a group setting of a packet is then terminated.

In the NIC illustrated in PTL 1, when a buffer being a distribution destination of a packet is changed, a packet cannot be sent from a destination distributing unit to a buffer after the change until all packets waiting in a buffer before the change are sent from the buffer and the buffer is empty.

On the other hand, in the NIC 11 in the present example embodiment, when a buffer being a distribution destination of a packet is changed, a packet while waiting is moved between buffers. Thus, in the NIC 11 in the present example embodiment, a packet is able to be sent from the destination distributing unit to a buffer even when all packets are not sent from a buffer before the change.

Thus, data are able to be efficiently transmitted to another communication apparatus in the NIC 11 in the present example embodiment in comparison with the NIC illustrated in PTL 1.

### Second Example Embodiment

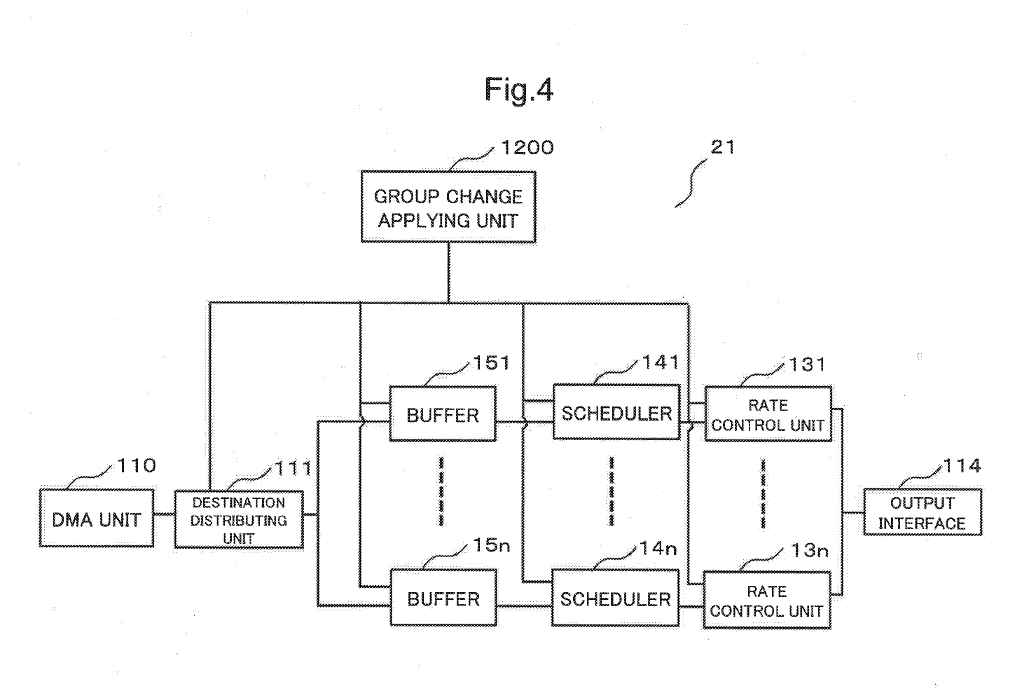

Next, a second example embodiment will be described with reference to FIGS. 4 to 6, 10, 11, and 13.

### [Description of Configuration]

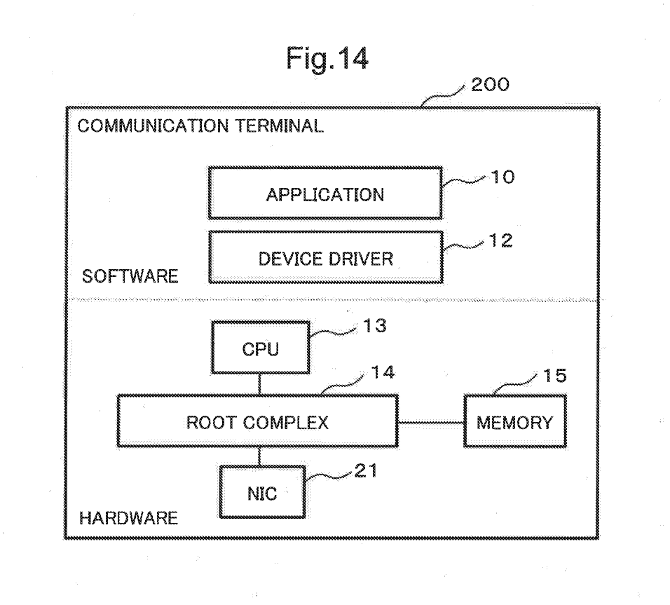

An overall configuration of the second example embodiment is illustrated in FIG. 14.

A communication terminal 200 in the second example embodiment illustrated in FIG. 14 includes an NIC 21 in the present example embodiment replacing the NIC 11 of the communication terminal 100 in the first example embodiment illustrated in FIG. 1.

Next, a configuration of the NIC 21 in the second example embodiment is illustrated in FIG. 4.

The configuration of the NIC 21 includes schedulers 141 to 14n located between the rate control units 131 to 13n and buffers 151 to 15n in the configuration of the NIC 11 in the first example embodiment illustrated in FIG. 2.

Further, the buffers 151 to 15n have functions different from those of the buffers 121 to 12n in the first example embodiment, and includes pointers each indicating a waiting position on a buffer as described later.

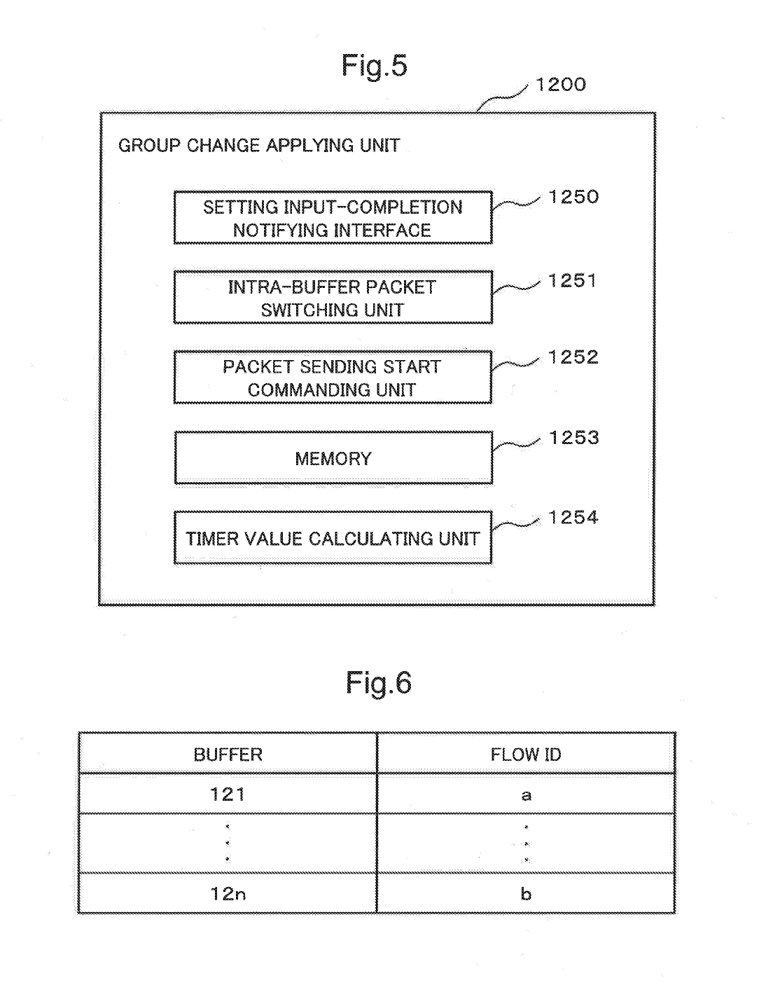

Furthermore, the group change applying unit 115 in the first example embodiment illustrated in FIGS. 2 and 3 is replaced with a group change applying unit 1200 in the present example embodiment illustrated in FIGS. 4 and 5 in the NIC 21.

The schedulers 141 to 14n each select an appropriate packet from a packet group in a buffer connected to each of the schedulers 141 to 14n, and each send the packet to the rate control units 131 to 13n connected to the respective schedulers 141 to 14n.

Further, as illustrated in FIG. 5, the group change applying unit 1200 includes a timer value calculating unit 1254 added to the group change applying unit 115 in the first example embodiment. As described later, when a setting of the destination distributing unit 111 is changed, the timer value calculating unit 1254 performs calculation to appropriately transfer timer values of the schedulers 141 to 14n.

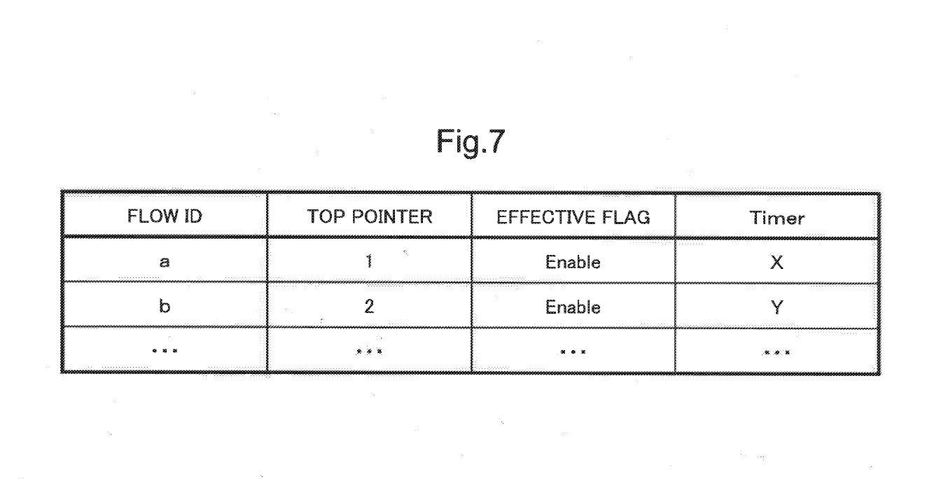

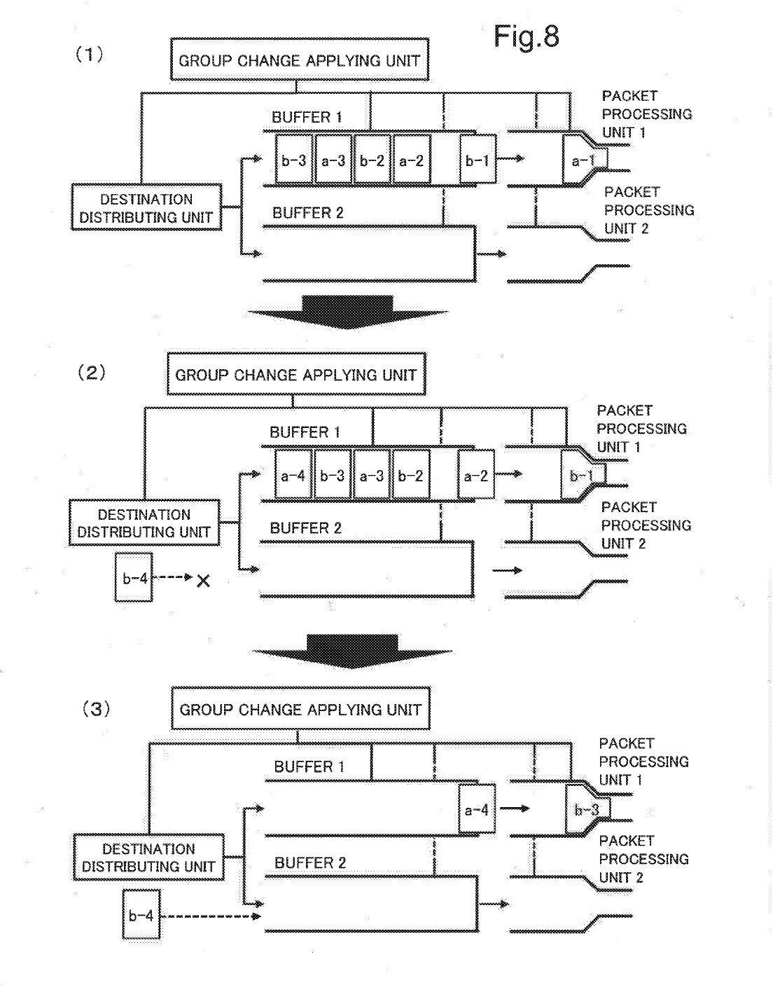

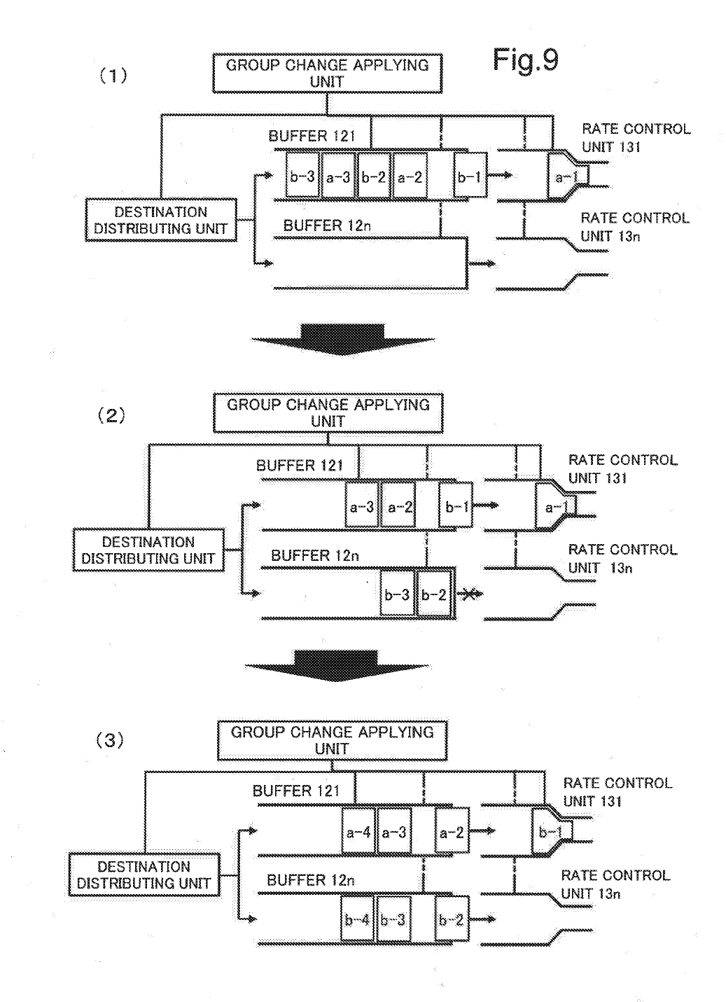

Each of the schedulers 141 to 14n possesses information about a buffer connected to each of the schedulers. FIG. 7 is an example of the buffer information. The buffer information is information in which a flow ID, a top pointer, an effective flag, and a timer value are associated with one another.

Herein, the buffer information will be described.

The flow ID is the same as that in the description of the first example embodiment.

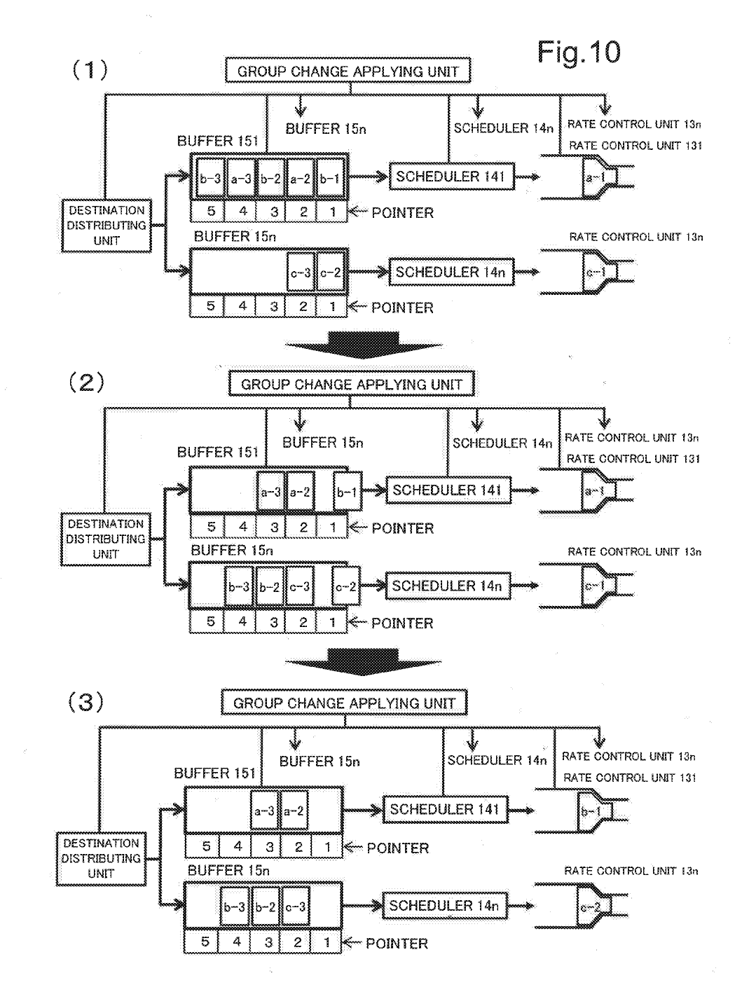

The pointer indicates a position in which a packet waits in a buffer. In the example of FIG. 10, the buffer 151 and the buffer 15n each include five pointers.

Further, the schedulers 141 to 14n possess information referred to as a coupling list in which an order of packets waiting in a buffer is associated with pointers of the waiting packets for each flow ID.

Herein, the coupling list will be described by using an example in which packets are waiting on a buffer as in FIG. 16.

FIG. 16 schematically illustrates packets waiting in a buffer. The buffer includes five pointers being waiting positions of the packets, and the pointers are provided with numbers from 1 to 5. In FIG. 16, a and b indicate flow IDs of the packets, and numbers provided to a and b such as a3 and b1 indicate an order of the packets.

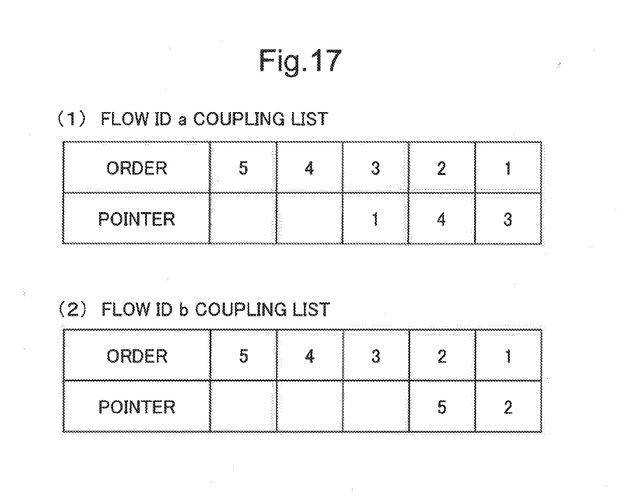

The scheduler possesses a coupling list in which an order of packets waiting on a buffer is associated with pointers of the waiting packets for each flow ID. Coupling lists when the packets wait as in FIG. 16 are illustrated in FIG. 17.

(1) of FIG. 17 is a coupling list in which the flow ID is a. An order of 1, 2, and 3 of packets having a as the flow ID is associated with respective pointers 3, 4, and 1. The packets having a as the flow ID are sent in order of the pointers 3, 4, and 1 on a buffer from the buffer, based on the coupling list.

(2) of FIG. 17 is a coupling list in which the flow ID is b. An order of 1 and 2 of packets having b as the flow ID is associated with respective pointers 2 and 5. The packets having b as the flow ID are sent in order of the pointers 2 and 5 on a buffer from the buffer, based on the coupling list.

Note that, a pointer corresponding to a first in an order in a coupling list is referred to as a top pointer.

Then, a new packet waits in an empty pointer after a top pointer is sent from a buffer.

The scheduler then deletes a sent packet from a coupling list. Then, the scheduler shifts the order of the pointers in the coupling list by one, and replaces the top pointer with a second pointer. Then, the scheduler associates a pointer of a packet newly waiting in the buffer with an end of the order of the coupling list.

The effective flag is a flag indicating whether or not a flow ID is effective. When the effective flag is effective (Enable), the schedulers 141 to 14n send packets from the buffers 151 to 15n to the rate control units 131 to 13n. Further, when the effective flag is ineffective (Disable), the schedulers 141 to 14n do not send packets from the buffers 151 to 15n to the rate control units 131 to 13n.

Note that, the schedulers 141 to 14n possess buffer information about buffers connected to the respective schedulers in the present example embodiment. However, each of the schedulers 141 to 14n may not possess the buffer information, and the group change applying unit 1200 may possess all pieces of the buffer information of all of the schedulers 141 to 14n.

Timer is a period of time in which a buffer waits after sending a certain packet until a next packet in the same flow is sent. When a buffer sends a certain packet, the timer value calculating unit 1254 of the group change applying unit 1200 illustrated in FIG. 5 starts timing, and a timer value in FIG. 7 decreases with an elapsed time. Then, when the timer value reaches zero, a packet of a top pointer is brought into a state of being able to be sent.

A rate at which the schedulers 141 to 14n send packets to the rate control units 131 to 13n is able to be ensured by setting the timer value to be greater than a rate of each packet.

Then, the schedulers 141 to 14n each select a packet in a flow in which the timer value is zero and timer is not set from packets waiting in the buffers 151 to 15n, and each send the packet to the respective rate control units 131 to 13n.

### [Description of Operation]

Next, operations in the present example embodiment will be described with reference to FIGS. 10 to 13.

FIG. 10 is a diagram for describing a flow of packets from the destination distributing unit 111 to the rate control units 131 to 13n in the NIC 21.

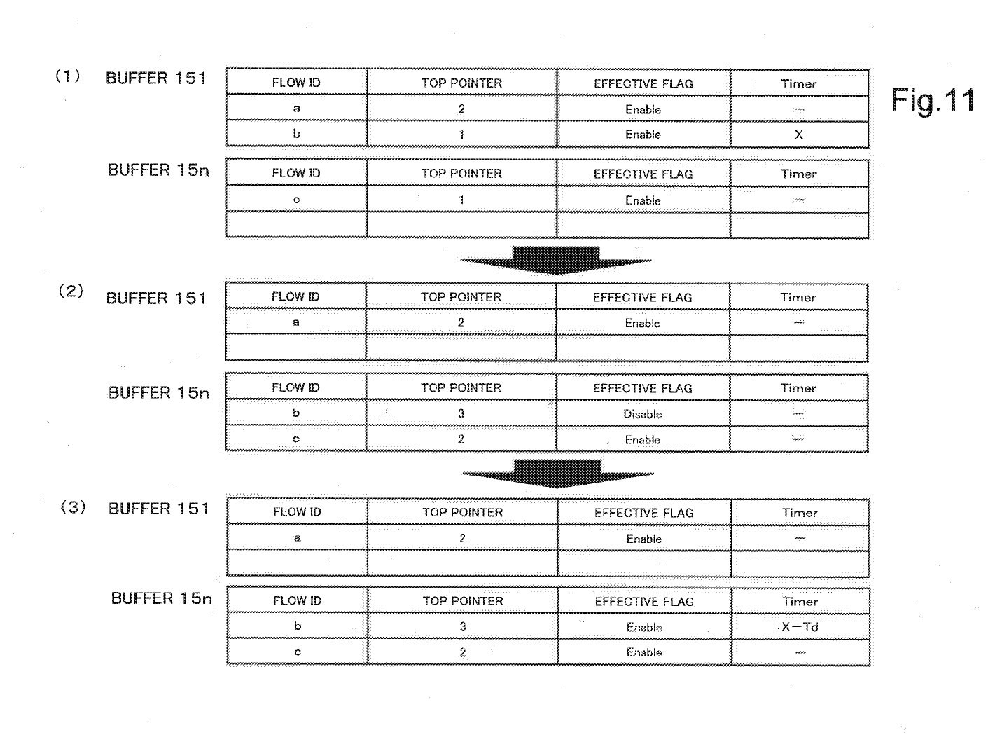

FIG. 11 is a diagram indicating values of the schedulers corresponding to FIG. 10.

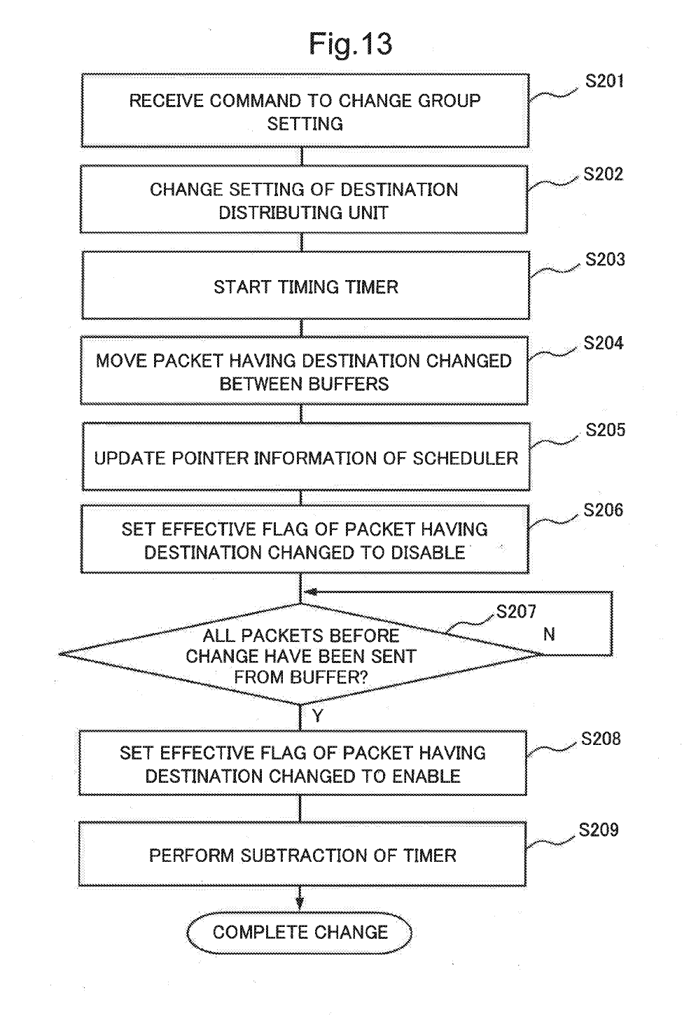

FIG. 13 is a flowchart illustrating operations in the present example embodiment.

In the flowchart in FIG. 13, Step S201 has an operation identical to that in Step S101 in FIG. 12 illustrating the operations in the first example embodiment, and thus description thereof will be omitted (S201).

In Step S201, it is assumed as in (1) of FIG. 10 that flows having a and b as the flow IDs are distributed to the buffer 151, a flow having c as the flow ID is distributed to the buffer 15n, and packets wait in the buffers as illustrated.

At the time of (1) of FIG. 10, pieces of information about the buffer 151 and the buffer 15n respectively possessed by the scheduler 141 and the scheduler 14n are illustrated in (1) of FIG. 11.

Next, the group change applying unit 1200 changes a setting of groups of the destination distributing unit 111, based on a command to change a group setting received in Step S201 (S202).

Subsequent to Step S202, the timer value calculating unit 1254 starts timing (S203).

Subsequently, the intra-buffer packet switching unit 1251 of the group change applying unit 1200 refers to the memory 1253 and compares the group setting after the change with a current group setting. Then, the intra-buffer packet switching unit 1251 moves a packet of a flow having a distributed destination buffer changed due to the change in the group setting among packets retained in the buffers 151 to 15n to a buffer after the change (S204). With an example of the operation in Step S204 being described with reference to FIG. 10, the packets b-2 and b-3 waiting in the buffer 151 illustrated in (1) of FIG. 10 are moved to the buffer 15n as in (2) of FIG. 10.

Subsequent to Step S204, a scheduler having a distribution destination of a flow ID changed among the schedulers 141 to 14n shifts a pointer next to a top pointer in an order in a coupling list possessed by the scheduler to a top pointer. Similarly, other pointers in the order are shifted by one. Furthermore, the scheduler having the distribution destination of the flow ID changed rewrites a top pointer in buffer information to a pointer identical to the top pointer in the coupling list (S205).

Then, the scheduler having the distribution destination of the flow ID changed sets an effective flag associated with the changed flow ID to Disable in the buffer information possessed by the scheduler. Then, the packet sending start commanding unit 1252 stops sending the flow set to Disable from the buffer to the rate control unit (S206).

The pieces of information about the buffer 151 and the buffer 15n respectively possessed by the scheduler 141 and the scheduler 14n at a stage when Step S205 and Step S206 are completed are illustrated in (2) of FIG. 11.

Herein, packets are retained in the destination distributing unit 111 without being distributed from the destination distributing unit 111 to a buffer while the intra-buffer packet switching unit 1151 switches the packets in Step S102 in FIG. 12 illustrating the operations in the first example embodiment.

On the other hand, packets are allowed to be distributed from the destination distributing unit 111 to the buffers 151 to 15n even while the intra-buffer packet switching unit 1251 switches the packets in Step S204 in FIG. 13 illustrating the operations in the present example embodiment. This is achieved because an order of packets in a flow is guaranteed by updating buffer information and a coupling list of each of the schedulers 141 to 14n in Step S205 and Step S206.

Subsequent to Step S206, the packet sending start commanding unit 1252 determines whether or not all the packets (packets b in FIG. 10) in the flow being switching targets in Step S204 have been sent from the buffer (buffer 151 in FIG. 10) before packet switching (S207).

In Step S207, when it is determined that all the packets being the switching targets have been sent from the buffer (Y in S207), processing proceeds to Step S208. In Step S207, when it is determined that not all the packets being the switching targets have been sent from the buffer (N in S207), processing returns to Step S207.

In Step S208, the packet sending start commanding unit 1252 instructs a scheduler being a movement destination of the flow to set an effective flag associated with the flow ID being the switching target to Enable (S208).

In Step S209 subsequent to Step S208, the timer value calculating unit 1254 refers to a timer value (assumed to be Td) at which the timing starts in Step S203. Then, the timer value calculating unit 1254 subtracts Td from a timer value of the flow ID corresponding to the flow in which the packets are switched between the buffers. Further, the memory 1253 rewrites information about a current group setting to a content of the group setting after the change (S209).

(3) of FIG. 11 illustrates an example in which Step S209 is completed. Herein, the timer value calculating unit 1254 subtracts the timer value Td referred in Step S209 from a timer value X being time at which the timing starts in Step S203.

In this way, a timer value corresponding to a flow moved from a buffer is transferred before and after movement.

Note that, in Step S209, Td is a negative value when sending of a packet in a flow being a switching target from a buffer before movement to a scheduler has been finished before switching of the packet between buffers is completed. In this case, a last packet in the flow being the switching target, which has been waiting in the buffer before the switching of the packet, has been sent from the buffer at an earlier time by X than an absolute value of Td.

Then, even when a timer value of a packet being sent next from a buffer after switching is set to a value obtained by subtracting an absolute value of Td from X, a rate of a previous packet is guaranteed, and the next packet is efficiently sent from the buffer without unnecessary waiting time.

After Step S209 is completed, the work of changing a group setting of a packet is then terminated.

In the NIC 11 in the first example embodiment, a packet arriving at the destination distributing unit cannot be sent to a buffer during the work of switching a packet.

However, in the NIC 21 in the present example embodiment, a packet arriving at the destination distributing unit is able to be sent to a buffer even during the work of switching a packet. Furthermore, a timer value reflecting time for the work of changing a group setting is able to be set to a packet in a flow having no opportunity to be sent during the work of changing a group setting by the group change applying unit.

### Third Example Embodiment

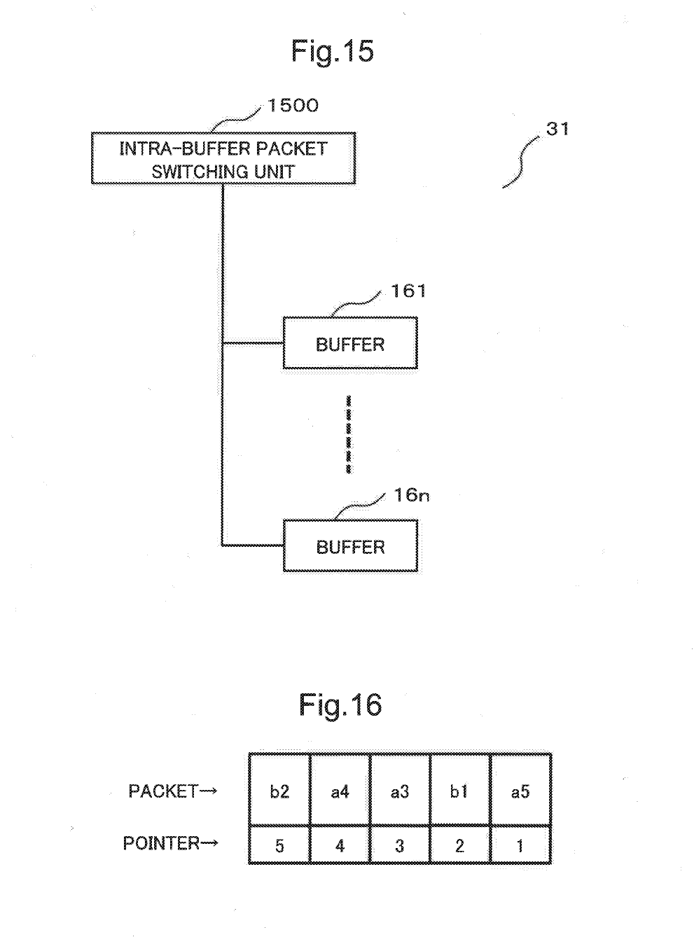

Next, a third example embodiment of the present invention will be described with reference to FIG. 15.

A communication apparatus 31 in the present example embodiment includes a plurality of buffers 161 to 16n that cause a communication packet to wait therein. The communication apparatus 31 further includes an intra-buffer packet switching unit 1500. The intra-buffer packet switching unit 1500 moves a predetermined communication packet among packets waiting in the plurality of buffers 161 to 16n from a first buffer in which the predetermined communication packet waits to a second buffer among the plurality of buffers.

As described above, the communication apparatus 31 in the present example embodiment is able to efficiently transmit data to another communication apparatus in comparison with the communication apparatus illustrated in PTL 1.

Note that, the present invention is also applicable when an information processing program achieving functions of the example embodiments is supplied to a device directly or remotely.

A part or the whole of the above-described example embodiments may also be described as in supplementary notes below, but is not limited thereto.

### (Supplementary Note 1)

A communication apparatus including:

a plurality of buffers configured to cause a communication packet to wait therein; and

an intra-buffer packet switching unit which moves a predetermined communication packet among packets waiting in the plurality of buffers from a first buffer in which the predetermined communication packet waits to a second buffer among the plurality of buffers.

### (Supplementary Note 2)

The communication apparatus according to supplementary note 1, further including:

a destination distributing unit which distributes a communication packet to the plurality of buffers and send the communication packet; and

a plurality of rate control units which sends the communication packet sent from the plurality of buffers at a predetermined rate.

### (Supplementary Note 3)

The communication apparatus according to supplementary note 1 or 2, further including:

a packet sending start commanding unit which instructs stop of sending the predetermined communication packet from the second buffer when the movement starts, and instructs sending of the predetermined communication packet from the second buffer when sending of all communication packets of a kind identical to a kind of the predetermined communication packet from the first buffer is detected.

### (Supplementary Note 4)

The communication apparatus according to supplementary note 1 or 2, further including:

a timer which indicates, when a timer value greater than a rate of the predetermined communication packet is set and the communication packet is sent from the buffer, a display value decreased from the timer value with a lapse of time; and

a timer value calculating unit which replaces a value obtained by subtracting the display value from the timer value with the timer value when the display value at a time of completion of the movement is a positive value, and replaces a value obtained by adding an absolute value of the display value to the timer value with the timer value when the display value at a time of completion of the movement is a negative value, wherein

the buffer is able to send a next communication packet of a kind identical to a kind of the communication packet waiting in the buffer when the display value becomes zero.

### (Supplementary Note 5)

A communication method including:

moving a predetermined communication packet among communication packets waiting in a plurality of buffers from a first buffer in which the predetermined communication packet waits to a second buffer among the plurality of buffers.

### (Supplementary Note 6)

The communication method according to supplementary note 5, wherein

the plurality of buffers output the communication packet to a plurality of rate control means configured to control a rate of a communication packet.

### (Supplementary Note 7)

The communication method according to supplementary note 5 or 6, further including:

stop sending the predetermined communication packet from the second buffer when the movement starts, and sending the predetermined communication packet from the second buffer when sending of all communication packets of a kind identical to a kind of the predetermined communication packet from the first buffer is detected.

### (Supplementary Note 8)

The communication method according to supplementary note 5 or 6, further including:

indicating, when a timer value greater than a rate of the predetermined communication packet is set and the communication packet is sent from the buffer, a display value decreased from the timer value with a lapse of time; and

replacing a value obtained by subtracting the display value from the timer value with the timer value when the display value at a time of completion of the movement is a positive value, and replacing a value obtained by adding an absolute value of the display value to the timer value with the timer value when the display value at a time of completion of the movement is a negative value, wherein

a next communication packet of a kind identical to a kind of the communication packet waiting in the buffer is able to be sent when the display value becomes zero.

### (Supplementary Note 9)

A program including:

moving a predetermined communication packet among communication packets waiting in a plurality of buffers from a first buffer in which the predetermined communication packet waits to a second buffer among the plurality of buffers.

### (Supplementary Note 10)

The program according to supplementary note 9, wherein

the plurality of buffers output the communication packet to a plurality of rate control means configured to control a rate of a communication packet.

### (Supplementary Note 11)

The program according to supplementary note 9 or 10, further including:

stop sending the predetermined communication packet from the second buffer when the movement starts, and sending the predetermined communication packet from the second buffer when sending of all communication packets of a kind identical to a kind of the predetermined communication packet from the first buffer is detected.

### (Supplementary Note 12)

The program according to supplementary note 9 or 10, further including:

indicating, when a timer value greater than a rate of the predetermined communication packet is set and the communication packet is sent from the buffer, a display value decreased from the timer value with a lapse of time;

replacing a value obtained by subtracting the display value from the timer value with the timer value when the display value at a time of completion of the movement is a positive value, and replacing a value obtained by adding an absolute value of the display value to the timer value with the timer value when the display value at a time of completion of the movement is a negative value; and

being able to send a next communication packet of a kind identical to a kind of the communication packet waiting in the buffer when the display value becomes zero.

The present invention has been described above by taking the above-mentioned example embodiments as exemplary examples. However, the present invention is not limited to the above-mentioned example embodiments. In other words, various aspects apparent to those skilled in the art may be applied to the present invention within the scope of the present invention.

This application is based upon and claims the benefit of priority from Japanese Patent Application No. 2016-085014, filed on Apr. 21, 2016, the disclosure of which is incorporated herein in its entirety by reference.

### REFERENCE SIGNS LIST

10 Application

11 NIC

12 Device driver

13 CPU

14 Root complex

15 Memory

21 NIC

31 Communication apparatus

100 Communication terminal

110 DMA unit

111 Destination distributing unit

114 Output interface

115 Group change applying unit

121, 12n Buffer

131, 13n Rate control unit

141, 14n Scheduler

151, 15n Buffer

161, 16n Buffer

200 Communication terminal

1150 Setting input-completion notifying interface

1151 Intra-buffer packet switching unit

1152 Packet sending start commanding unit

1153 Memory

1200 Group change applying unit

1250 Setting input-completion notifying interface

1251 Intra-buffer packet switching unit

1252 Packet sending start commanding unit

1253 Memory

1254 Timer value calculating unit

1500 Intra-buffer packet switching unit

What is claimed is:

1. A communication apparatus comprising:
a plurality of buffers configured to cause a communication packet to wait therein; and
an intra-buffer packet switch configured to move a predetermined communication packet among packets waiting in the plurality of buffers from a first buffer in which the predetermined communication packet waits to a second buffer among the plurality of buffers.

2. The communication apparatus according to claim 1, further comprising:
a destination distributor configured to distribute a communication packet to the plurality of buffers and send the communication packet; and
a plurality of rate controllers configured to send the communication packet sent from the plurality of buffers at a predetermined rate.

3. The communication apparatus according to claim 1, further comprising
a packet sending start commanding unit configured to instruct stop of sending the predetermined communication packet from the second buffer when the movement starts, and instruct sending of the predetermined communication packet from the second buffer when sending of all communication packets of a kind identical to a kind of the predetermined communication packet from the first buffer is detected.

4. The communication apparatus according to claim 1, further comprising:
a timer which indicates, when a timer value greater than a rate of the predetermined communication packet is set and the communication packet is sent from the buffer, a display value to be decreased from the timer value with a lapse of time; and
a timer value calculator configured to replace a value obtained by subtracting the display value from the timer value with the timer value when the display value at a time of completion of the movement is a positive value, and replace a value obtained by adding an absolute value of the display value to the timer value with the timer value when the display value at a time of completion of the movement is a negative value, wherein
the buffer is able to send a next communication packet of a kind identical to a kind of the communication packet waiting in the buffer when the display value becomes zero.

5. A communication method comprising:
moving a predetermined communication packet among communication packets waiting in a plurality of buffers from a first buffer in which the predetermined communication packet waits to a second buffer among the plurality of buffers.

6. The communication method according to claim 5, wherein
the plurality of buffers output the communication packet to a plurality of rate controllers configured to control a rate of a communication packet.

7. The communication method according to claim 5, further comprising:
stopping sending the predetermined communication packet from the second buffer when the movement starts, and sending the predetermined communication packet from the second buffer when sending of all communication packets of a kind identical to a kind of the predetermined communication packet from the first buffer is detected.

8. The communication method according to claim 5, further comprising:
indicating, when a timer value greater than a rate of the predetermined communication packet is set and the communication packet is sent from the buffer, a display value to be decreased from the timer value with a lapse of time; and
replacing a value obtained by subtracting the display value from the timer value with the timer value when the display value at a time of completion of the movement is a positive value, and replacing a value obtained by adding an absolute value of the display value to the timer value with the timer value when the display value at a time of completion of the movement is a negative value, wherein
a next communication packet of a kind identical to a kind of the communication packet waiting in the buffer is able to be sent when the display value becomes zero.

9. A recording medium that records a program causing a computer to
move a predetermined communication packet among communication packets waiting in a plurality of buffers from a first buffer in which the predetermined communication packet waits to a second buffer among the plurality of buffers.

10. The recording medium according to claim 9, wherein
the program further causes a computer to
stop sending the predetermined communication packet from the second buffer when the movement starts, and send the predetermined communication packet from the second buffer when sending of all communication packets of a kind identical to a kind of the predetermined communication packet from the first buffer is detected.

11. The recording medium according to claim 9, wherein
the program further causes a computer to
indicate, when a timer value greater than a rate of the predetermined communication packet is set and the communication packet is sent from the buffer, a display value to be decreased from the timer value with a lapse of time,
replace a value obtained by subtracting the display value from the timer value with the timer value when the display value at a time of completion of the movement is a positive value, and replace a value obtained by adding an absolute value of the display value to the timer value with the timer value when the display value at a time of completion of the movement is a negative value, and
be able to send a next communication packet of a kind identical to a kind of the communication packet waiting in the buffer when the display value becomes zero.
